(19) United States
(12) Patent Application Publication
(10) Pub. No.: US 2008/0004746 A1
(43) Pub. Date: Jan. 3, 2008

(54) Live tape position sensor

(76) Inventors: Duane B. Jahnke, Harford, WI (US); Todd K. Pichler, New Berlin, WI (US); Mike J. Reilly, Mukwonago, WI (US); Dave J. Rollmann, New Berlin, WI (US)

Correspondence Address: Mark Shires;c/o International Product Tech., 3100 S. 166th St., New Berlin, WI, 53151, US

(21) Appl. No.: 11/823,753

(22) Filed: Jun. 28, 2007

Related U.S. Application Data
(60) Provisional application No. 60/818,103, filed on Jun. 30, 2006.

(51) Int. Cl. G06F 7/00

(52) U.S. Cl. 700/229; 356/614; 206/710; 206/717

(57) ABSTRACT

A real-time tape position sensor to accurately determine the location of several consecutive carrier tape pockets in order to pick or place electronic semiconductor devices into or out of a tape pocket. The invention generates an on-going map of the pocket locations by coupling data from a photosensor inspecting between the tape pockets with data from an encoder that records the position of the carrier tape as it moves.

### BACKGROUND

1. Field of the Invention

The electronic semiconductor industry uses carrier tape to transport and handle electronic devices. This carrier tape has pockets formed into it to hold electronic devices. The locations of these pockets must be know precisely in order for automated equipment to accurately pick or place a device into such a pocket. The present invention relates to a live tape position sensor to more accurately determine the position of several consecutive tape pockets in order to place an electronic semiconductor device into a tape pocket or to pick an electronic semiconductor device out of a tape pocket.

2. Prior Art

For reference, FIG. 1 illustrates carrier tape 1 with pockets 2, sprocket holes 3, and pocket holes 4. There are electronic semiconductor devices 5 shown in some pockets. A common method of the prior art is shown in FIG. 2, which depicts a side view of a section of carrier tape 1. The tape moves horizontally according to the direction indicated by arrow 16. A stationary photosensor 6 is positioned to sense the leading edge (or sometimes the trailing edge) of a tape pocket 2. The tape is advanced until the leading edge of a tape pocket is sensed, at which time the tape movement is stopped. A device 5 can then be inserted into (or removed from) the tape at this fixed location. Then the tape again advances until the next leading edge of a tape pocket is sensed. It is desirable to advance the tape as quickly as possible to increase the overall speed of the machine. Unfortunately, when indexing the tape at high speed it is difficult to stop it immediately when the next tape pocket is sensed. Consequently the exact location of the tape pocket is often unknown. Alternatively, some prior art tape pocket sensors are positioned to sense the pocket holes 4 instead of the pockets themselves. Alternatively again, some prior art tape pocket sensors are positioned to sense sprocket holes 3 along the flange of the tape. The pitch of the tape pockets is always a multiple of the sprocket hole pitch, so by counting sprocket holes, the pocket locations can be determined. U.S. Pat. No. 7,073,696 to College (2006) describes a carrier tape indexing method that uses an encoder on a sprocket wheel. However, due to manufacturing inaccuracies, the sprocket hole positions can vary from the pocket positions by 0.010 inches or more. Therefore, referencing the sprocket holes is less accurate.

Sensing just the leading or just the trailing edge of a tape pocket, or a related hole, does not always yield the best information of the pocket location, even when the pocket size is known, due to the various sensitivity of the sensor. A photosensor might be set to trigger when it is slightly dimmed or very dim, and thus trigger at different locations relative to the pocket. Another problem with conventional tape position sensors is that the location of the photosensor often has to be moved when a tape with different pocket size is used because the desired pick or place location may need to be changed. Also, if placing devices into the tape at different locations, then multiple sensors are needed. Another problem with conventional tape position sensors that require the tape to stop when the sensor is triggered is that the tape often stretches or moves slightly after the tape positioner mechanism has stopped. This movement is unaccounted for.

In these respects, the live tape position sensor according to the present invention substantially departs from the conventional concepts and designs of the prior art, and in so doing provides an apparatus to more accurately determine the location of several consecutive tape pockets in order to place an electronic device into a tape pocket or to pick an electronic device out of a tape pocket.

### SUMMARY OF THE INVENTION

The present invention provides a new live tape position sensor method to more accurately determine the location of several consecutive tape pockets in order to place an electronic device into a tape pocket or to pick an electronic device out of a tape pocket.

To attain this, the present invention generally comprises a photosensor, a tape drive mechanism, a tape tension mechanism, a high-resolution encoder, and an electronic controller that receives input from the photosensor and encoder.

The primary object is to more accurately know the location of a tape pocket. A second object is to more accurately know the location of several consecutive tape pockets. Third, an object is know the pocket locations even if the tape has stopped in a position that is different from the intended stopping position. Fourth, the invention needs no mechanical adjustment when changing to different size tape pockets. Fifth, the invention requires only one photosensor to yield high accuracy because it senses both the leading and trailing edges of each pocket and thus accommodates sensor hysteresis. Sixth, the invention accurately determines pocket locations regardless of irregularities in the tape itself. Irregularities include pocket pitch variations, pocket size variations, and pocket side wall shape variations.

### BRIEF DESCRIPTION OF THE DRAWINGS

FIG. 1 is an isometric illustration of a piece of carrier tape with some electronic devices in some pockets.

FIG. 2 is a side view illustration of prior art.

FIG. 3 is a side view of the invention.

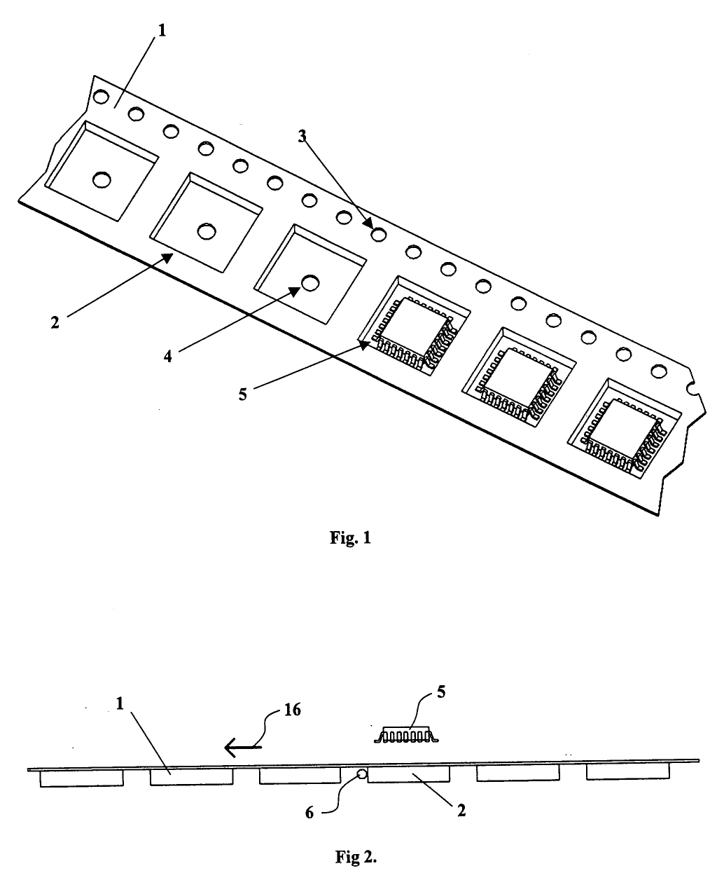

### DETAILED DESCRIPTION OF THE INVENTION

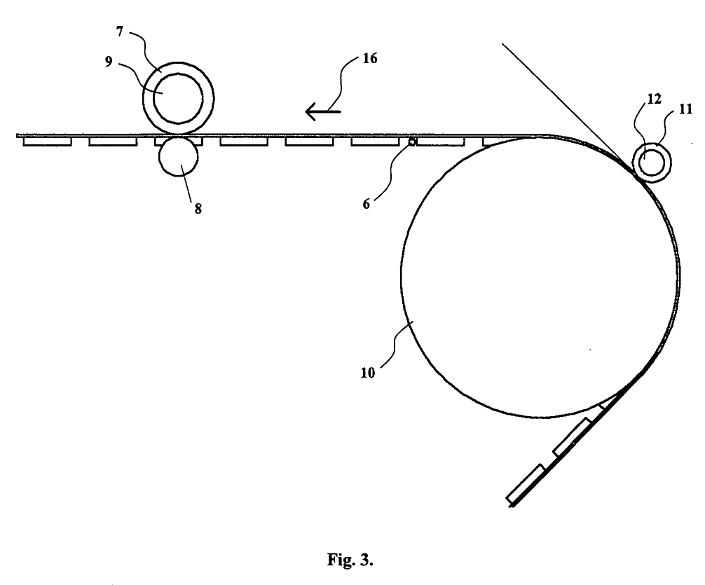

FIG. 3 illustrates a preferred embodiment of the present invention. The invention generally comprises a photosensor 6, tape drive wheel 7, tape drive roller 8, tape drive motor 9, tape tension wheel 10, tape tension roller 11, a high-resolution encoder 12, and an electronic processor.

The photosensor 6 is a common thru-beam photosensor that consists of an emitter and a detector. This is an LED based product such as Keyence #FU59. The photosensor has an LED which is constantly on. The LED light travels thru a fiber optic cable to an emit location. A receiving fiber optic cable is positioned opposite the emitter on the opposite side of the tape. This fiber optic cable attaches to an amplifier and circuit which acts as an indicator switch when activated. The photosensor may be retro-reflective. The photosensor may eliminate the fiber optics. Other types of sensors such as a proximity sensor would also work.

The tape drive wheel 7 is a cylindrically shaped wheel made of hard rubber or a similar material. The material could vary. Alternatively a sprocket wheel could be used to drive the tape.

The tape drive roller 8 consists of two coaxial cylindrically shaped rollers made of hard rubber or a similar material. It is used to create an opposing force for the Tape Drive Wheel 7. The material could vary. The rollers straddle the tape pockets and contact the flange of the tape. The distance between the tape drive rollers can be adjusted to accommodate various width tape pockets.

The tape drive motor 9 is an electric motor. This motor could be a stepper motor, a servomotor, a direct current motor or an alternating current motor. Other actuators could also work. The tape drive motor is attached to the tape drive wheel.

The tape tension wheel 10 consists of two coaxial cylindrically shaped wheels made of metal or a similar material. The material could vary. The wheels straddle the tape pockets and contact the flange of the tape. The distance between the tape tension wheels can be adjusted to accommodate various width tape pockets. Alternatively a sprocket wheel could provide tension.

The tape tension roller 11 is a cylindrically shaped roller made of hard rubber or similar material. It is used to create an opposing force for the tape tension wheel. The material could vary.

The tape tension wheel and tape tension roller provide tension on the tape to keep it taught between said components and the tape drive roller and motor.

The high-resolution encoder 12 is a device that attaches to the end of a rotary shaft and electrically outputs data about the rotational location of the shaft. In the preferred embodiment it attaches to the shaft of the tape tension roller 11, but it could attach to any of the aforementioned wheels or rollers.

The electronic processor is a microprocessor that is electronically connected to the high-resolution encoder and the photosensor. It reads the data from the encoder and the photosensor to create a map of tape pocket locations versus encoder data.

The tape is loaded by feeding it around the tape tension wheel 10 and between the tape tension roller 11. The tape tension roller puts pressure against the flange of the tape so that the tape is pinched between the tape tension roller and the tape tension wheel. The tape is further loaded by feeding it between the tape drive wheel 7 and the tape drive roller 8. The tape drive wheel and the tape drive roller are under tension to pinch the tape flange such that when the tape drive wheel rotates under the activation of the electric motor 9, the tape is consequently moved as desired. The section of tape between the tape drive wheel 7 and the tape tension roller 11 remains taut during the operation of the invention.

The high-resolution encoder 12 is attached to the shaft of the tape tension roller so as to measure the rotation of the tape tension roller and thus the movement of the tape. The photosensor 6 is positioned to sense in between pockets after the tape has passed around the tape tension wheel. The high-resolution encoder could be attached to a sprocket wheel that engages the sprocket holes in the tape. The high-resolution encoder could attach to a roller located on the underside of the tape or to one of the other rotational devices that rotates along with the tape movement. The photosenser could be a retroreflective sensor, or a laser sensor, or another type of sensor.

The tape is advanced thru the system by activating the tape drive motor 9. The tape advances in the direction indicated by arrow 16. As the tape moves, photosensor 6 senses the leading and trailing edge of each pocket. When each pocket edge is detected, the high-resolution encoder value is noted via an electronic processor. As tape advances, an accurate map of tape pocket locations relative to encoder values is made. By sensing the leading and trailing edge of each pocket, the exact middle of the pocket can be known by bisecting the edges. This works regardless of the sensitivity setting of the photosensor. Even variations in pocket locations in the tape can be compensated for (i.e. pocket pitch variations). By querying a current value from the encoder at any time, an electronic processor can determine the current middle location of pockets accessible to the pick-n-place that recently passed by the photosensor. For example, when the leading edge of the first tape pocket triggers the photosensor to switch on, the encoder value is X₁. When the trailing edge of the pocket triggers the photosensor to switch off, the encoder value is X₂. The tape continues to move and then is stopped. The encoder value is queried and found to read X₃. The location of the leading edge of the tape pocket can be calculated as X₃−X₁, where this value represents the distance from the photosensor to the leading edge of the tape pocket. The trailing edge of the tape pocket can be calculated as X₃−X₂. Thus the center of the tape pocket can be calculated as the average of these 2 distances as ((X₃−X₂)+(X₃−X₁₎)/2. These distances can be calculated for any of the tape pockets between tape drive wheel 7 and photosensor 6.

In this invention, any inaccuracy of stopping the tape at a specific location can be compensated for because the pick-n-place can adjust its pick or placement location according to live information regarding the exact tape pocket location.

What is claimed is:

1. A real-time carrier tape pocket position sensor to accurately determine the location of at least one tape pocket in order to pick or place electronic semiconductor devices into or out of said tape pocket, said position sensor comprising:
a) a photosensor positioned to sense the leading and trailing edges of tape pockets,
b) a rotational device that turns in accordance with the movement of said tape,
c) a rotary encoder that is mechanically coupled to said rotational device so as to turn proportionally with said rotational device,
d) an electronic processor that stores and correlates data from said rotary encoder with data from said photosensor so that the current location of at least one tape pocket that has passed said photosensor can be determined.

2. A tape pocket position sensor as in claim 1 where the center location a pocket is determined by bisecting the leading and trailing edge data from said photosensor and said rotary encoder.

3. A real-time carrier tape pocket position sensor to accurately determine the location of several consecutive tape pockets in order to pick or place electronic semiconductor devices into or out of said tape pockets, said position sensor comprising:
a) a photosensor positioned to sense the leading and trailing edges of tape pockets,
b) a rotational device that turns in accordance with the movement of said tape,
c) a rotary encoder that is mechanically coupled to said rotational device so as to turn proportionally with said rotational device,
d) an electronic processor that stores the encoder value when the leading edge of a tape pocket is sensed and that stores the encoder value when the trailing edge of a tape pocket is sensed and further can determine the present location of said tape pocket relative to said photosensor by referencing the current encoder value with the previously stored values.

4. A method to accurately determine the location a tape pocket in order to pick or place electronic semiconductor devices into or out of said tape pockets, said method comprising:
a) positioning a photosensor to sense the leading or trailing or both edges of tape pockets,
b) positioning a rotational device to turn in accordance with the movement of said tape,
c) positioning a rotary encoder that is mechanically coupled to said rotational device so as to turn proportionally with said rotational device,
d) utilizing an electronic processor to store the values read from said encoder when the leading edge and trailing edge of a tape pocket is sensed,
e) utilizing an said electronic processor to determine the present location of a tape pocket by performing a mathematical calculation on the current encoder value and a previously stored value.

5. A method as in claim 4 whereby the locations of multiple tape pockets are determined.
